(19) United States
(12) Patent Application Publication
(10) Pub. No.: US 2019/0299971 A1
(43) Pub. Date: Oct. 3, 2019

(54) CONTROL DEVICE OF HYBRID VEHICLE

(71) Applicant: TOYOTA JIDOSHA KABUSHIKI KAISHA, Toyota-shi (JP)

(72) Inventors: Tomoya TAKAHASHI, Ebina-shi (JP); Mitsuhiro TABATA, Sunto-gun (JP)

(73) Assignee: TOYOTA JIDOSHA KABUSHIKI KAISHA, Toyota-shi (JP)

(21) Appl. No.: 16/299,713

(22) Filed: Mar. 12, 2019

(30) Foreign Application Priority Data
Apr. 2, 2018 (JP) 2018-070865

(51) Int. Cl. B60W 20/13; B60K 6/40; B60W 10/06; B60W 10/08

(52) U.S. Cl. CPC B60W 20/13; B60K 6/40; B60W 10/06; B60W 10/08; B60Y 2200/92; B60W 2710/08; B60W 2510/244; B60W 2550/142; B60W 2710/06

(57) ABSTRACT

The control device of hybrid vehicle 1 comprises: a target state-of-charge setting part 42 configured to set a target state of charge which is a target value of a state of charge of the battery 20; and an output control part 41 configured to control outputs of the internal combustion engine 10 and the electric motor 16 so that the state of charge of the battery becomes equal to or more than the target state of charge when the hybrid vehicle is being driven outside a charging location. The target state-of-charge setting part is configured to set the target state of charge based on an amount of electric power required for the hybrid vehicle to reach the charging location by output of only the electric motor, and grade information of a road near the charging location.

### FIELD

The present invention relates to a control device of a hybrid vehicle.

### BACKGROUND

Known in the art is a hybrid vehicle provided with an internal combustion engine, an electric motor, and a battery supplying electric power to the electric motor. In some hybrid vehicles, to charge the battery, not only the output of the internal combustion engine, but also an external power source can be used.

In a hybrid vehicle able to use an external power source to charge a battery (for example, a plug-in hybrid), ideally the electric power charged into the battery is used up before the next charging operation by an external power source of a charging location. Due to this, it is possible to keep the operating time of the internal combustion engine to the minimum and in turn possible to improve a fuel efficiency and exhaust emission of the hybrid vehicle.

Further, if driving the hybrid vehicle by only the output of the electric motor from a current location to the charging location, the amount of electric power required until reaching the charging location becomes greater the longer the distance from the current location to the charging location. For this reason, in the hybrid vehicle described in PTL 1, the outputs of the internal combustion engine and electric motor are controlled so that the state of charge of the battery becomes equal to or more than the target state of charge, and the target state of charge is lowered the closer the hybrid vehicle to the charging location.

### CITATION LIST

### Patent Literature

[PTL 1] Japanese Unexamined Patent Publication No. 2016-013792

### SUMMARY

### Technical Problem

However, a driver of a hybrid vehicle changes the destination while driving according to the circumstances. For this reason, even if the hybrid vehicle is being driven near a charging location, the hybrid vehicle will sometimes not be stopped at the charging location.

When the target state of charge at a charging location is substantially zero, if the hybrid vehicle bypasses the charging location, the hybrid vehicle cannot use the electric power of the battery much at all. In this case, the electric motor cannot be used as the power source for driving use or the output of the electric motor has to be limited, so the power performance of the hybrid vehicle falls. In particular, when the hybrid vehicle bypasses the charging location, then is driven along an uphill slope, if the maximum output of the internal combustion engine is smaller than the maximum output of the electric motor etc., the output for driving use becomes insufficient compared with the output demanded by the driver and the fall in power performance becomes remarkable.

Therefore, considering the above technical problem, an object of the present invention is to shorten the operating time of the internal combustion engine while keeping the power performance of the hybrid vehicle from falling.

### Solution to Problem

The summary of the present disclosure is as follows.

(1) A control device of a hybrid vehicle for controlling a hybrid vehicle comprising an internal combustion engine, electric motor, and a battery supplying electric power to the electric motor and able to be charged by output of the internal combustion engine and an external power source, the control device of hybrid vehicle comprising: a target state-of-charge setting part configured to set a target state of charge which is a target value of a state of charge of the battery; and an output control part configured to control outputs of the internal combustion engine and the electric motor so that the state of charge of the battery becomes equal to or more than the target state of charge when the hybrid vehicle is being driven outside a charging location, wherein the target state-of-charge setting part is configured to set the target state of charge based on an amount of electric power required for the hybrid vehicle to reach the charging location by output of only the electric motor, and grade information of a road near the charging location.

(2) The control device of a hybrid vehicle described in above (1), further comprising a grade information detecting part configured to detect the grade information based on a driving history of the hybrid vehicle.

(3) The control device of a hybrid vehicle described in above (2), further comprising a grade information detecting part configured to detect the grade information based on a driving history of the hybrid vehicle.

(4) The control device of a hybrid vehicle described in any one of above (1) to (3), wherein the target state-of-charge setting part is configured to set the target state of charge so that the state of charge of the battery becomes an arrival state of charge when the hybrid vehicle reaches the charging location, and raise the arrival state of charge if there is an uphill slope near the charging location compared to if there is no uphill slope near the charging location.

(5) The control device of a hybrid vehicle described in above (4), wherein the target state-of-charge setting part is configured to raise the arrival state of charge the shorter a distance from the charging location to the uphill slope.

(6) The control device of a hybrid vehicle described in above (4), wherein the target state-of-charge setting part is configured to raise the arrival state of charge the shorter a driving time of the hybrid vehicle from the charging location to the uphill slope.

(7) The control device of a hybrid vehicle described in any one of above (4) to (6), wherein the target state-of-charge setting part is configured to raise the arrival state of charge the larger an amount of electric power of the battery consumed at the uphill slope.

(8) The control device of a hybrid vehicle described in above (7), wherein the target state-of-charge setting part is configured to raise the arrival state of charge the larger a grade of the uphill slope.

(9) The control device of a hybrid vehicle described in above (7) or (8), wherein the target state-of-charge setting part is configured to raise the arrival state of charge the longer the uphill slope.

(10) The control device of a hybrid vehicle described in any one of above (4) to (9), wherein the target state-of-charge setting part is configured to lower the arrival state of charge the lower a frequency by which the hybrid vehicle is driven along the uphill slope when being driven near the charging location.

(11) The control device of a hybrid vehicle described in any one of above (1) to (10), wherein the target state-of-charge setting part is configured to set the target state of charge so that the state of charge of the battery becomes an arrival state of charge when the hybrid vehicle reaches the charging location, and lower the arrival state of charge if there is a downhill slope near the charging location compared to if there is no downhill slope near the charging location.

(12) The control device of a hybrid vehicle described in any one of above (1) to (3), wherein if there is an uphill slope near the charging location, the target state-of-charge setting part is configured to calculate a first target state of charge based on an amount of electric power required for the hybrid vehicle to reach the charging location by output of only the electric motor, calculate a second target state of charge based on an amount of electric power able to be charged to the battery by output of the internal combustion engine from a current location of the hybrid vehicle to the uphill slope, set the target state of charge to the first target state of charge when the first target state of charge is equal to or more than the second target state of charge, and set the target state of charge to the second target state of charge when the first target state of charge is less than the second target state of charge.

(13) The control device of a hybrid vehicle described in above (12), wherein the target state-of-charge setting part is configured to raise the second target state of charge the larger an amount of electric power of the battery consumed on the uphill slope.

(14) The control device of a hybrid vehicle described in above (13), wherein the target state-of-charge setting part is configured to raise the second target state of charge the larger a grade of the uphill slope.

(15) The control device of a hybrid vehicle described in above (13) or (14), wherein the target state-of-charge setting part is configured to raise the second target state of charge the longer the uphill slope.

(16) The control device of a hybrid vehicle described in any one of above (12) to (15), wherein the target state-of-charge setting part is configured to lower the second target state of charge the lower a frequency by which the hybrid vehicle is driven along the uphill slope when being driven near the charging location.

(17) The control device of a hybrid vehicle described in any one of above (1) to (16), wherein the target state-of-charge setting part is configured to maintain the target state of charge at a predetermined threshold value if a current location of the hybrid vehicle cannot be detected.

### Advantageous Effects of Invention

According to the present invention, it is possible to shorten the operating time of the internal combustion engine while keeping the power performance of the hybrid vehicle from falling.

### BRIEF DESCRIPTION OF DRAWINGS

FIG. 1 is a view schematically showing the configuration of a hybrid vehicle according to a first embodiment of the present invention.

FIG. 2 is a block diagram schematically showing the configuration of a control device of a hybrid vehicle etc., according to the first embodiment of the present invention.

FIG. 3 is a view schematically showing a relationship between a distance to a charging location and a target SOC.

FIG. 4 is a flow chart showing a control routine of processing for calculation of an arrival SOC in the first embodiment of the present invention.

FIG. 5 is a flow chart showing a control routine of processing for calculation of the target SOC in the first embodiment of the present invention.

FIG. 6 is a flow chart showing a control routine of processing for setting a driving mode in the first embodiment of the present invention.

FIG. 7 is a block diagram schematically showing the configuration of a control device of a hybrid vehicle etc., according to a second embodiment of the present invention.

FIG. 8 is a flow chart showing a control routine of processing for calculation of the arrival SOC in the second embodiment of the present invention.

FIG. 9 is a view showing a drive path of a hybrid vehicle near a charging location.

FIG. 10 is a view showing an example of setting the target SOC in a third embodiment.

FIG. 11 is a flow chart showing a control routine of processing for setting the target SOC in the third embodiment of the present invention.

FIG. 12 is a flow chart showing a control routine of processing for calculation of the target SOC in a fourth embodiment of the present invention.

### DESCRIPTION OF EMBODIMENTS

Below, referring to the drawings, embodiments of the present invention will be explained in detail. Note that, in the following explanation, similar components are assigned the same reference signs.

### First Embodiment

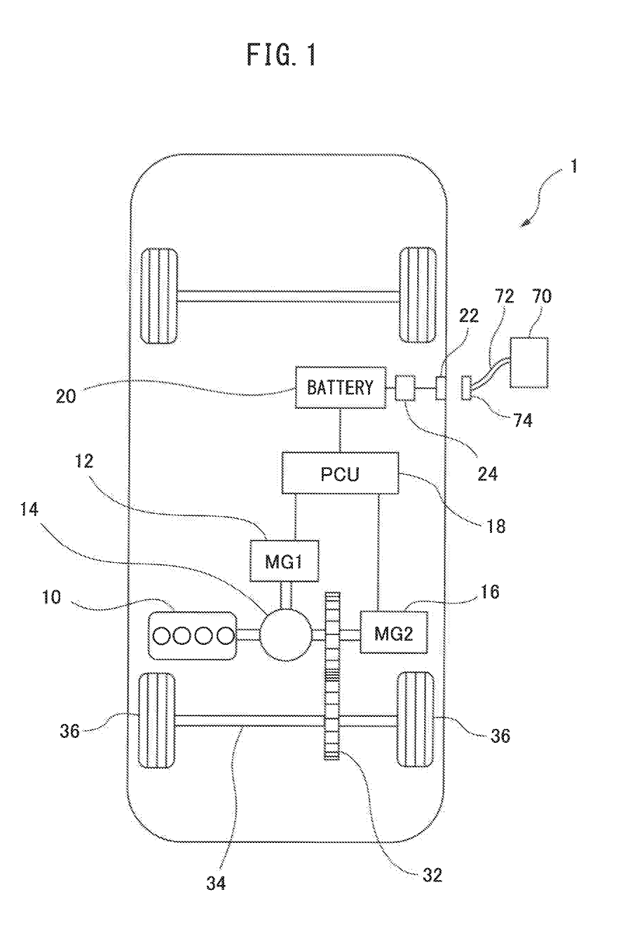

Below, referring to FIG. 1 to FIG. 6, a first embodiment of the present invention will be explained.

<Configuration of Hybrid Vehicle>

FIG. 1 is a view schematically showing the configuration of a hybrid vehicle 1 according to the first embodiment of the present invention. A hybrid vehicle (below, simply referred to as the “vehicle”) 1 is provided with an internal combustion engine 10, first motor-generator 12, power distributing mechanism 14, second motor-generator 16, power control unit (PCU) 18, and battery 20.

The internal combustion engine 10 burns an air-fuel mixture of fuel and air in cylinders to output power. The internal combustion engine 10, for example, is a gasoline engine or diesel engine. An output shaft of the internal combustion engine 10 (crankshaft) is mechanically connected to the power distributing mechanism 14, and output of the internal combustion engine 10 is input to the power distributing mechanism 14.

The first motor-generator 12 functions as a generator and motor. The first motor-generator 12 is mechanically connected to the power distributing mechanism 14, and the output of the first motor-generator 12 is input to the power distributing mechanism 14. Further, the first motor-generator 12 is electrically connected to the PCU 18. When the first motor-generator 12 functions as a generator, the electric power generated by the first motor-generator 12 is supplied through the PCU 18 to at least one of the second motor-generator 16 and battery 20. On the other hand, when the first motor-generator 12 functions as a motor, the electric power stored in the battery 20 is supplied through the PCU 18 to the first motor-generator 12.

The power distributing mechanism 14 is configured as a known planetary gear mechanism including a sun gear, ring gear, pinion gears, and a planetary carrier. The output shaft of the internal combustion engine 10 is coupled with the planetary carrier, the first motor-generator 12 is coupled with the sun gear, and a speed reducer 32 is coupled with the ring gear. The power distributing mechanism 14 distributes the output of the internal combustion engine 10 to the first motor-generator 12 and the speed reducer 32.

Specifically, when the first motor-generator 12 functions as a generator, the output of the internal combustion engine 10 input to the planetary carrier is distributed to the sun gear coupled with the first motor-generator 12 and the ring gear coupled with the speed reducer 32 in accordance with the gear ratio. The output of the internal combustion engine 10 distributed to the first motor-generator 12 is used to generate electric power by the first motor-generator 12. On the other hand, the output of the internal combustion engine 10 distributed to the speed reducer 32 is transmitted as power for driving use through an axle 34 to the wheels 36. Therefore, the internal combustion engine 10 can output power for driving use. Further, when the first motor-generator 12 fimctions as a motor, the output of the first motor-generator 12 is supplied through the sun gear and planetary carrier to the output shaft of the internal combustion engine 10 whereby the internal combustion engine 10 is cranked.

The second motor-generator 16 functions as a generator and motor. The second motor-generator 16 is mechanically connected to the speed reducer 32, and the output of the second motor-generator 16 is supplied to the speed reducer 32. The output of the second motor-generator 16 supplied to the speed reducer 32 is transmitted as power for driving use to the wheels 36 through the axle 34. Therefore, the second motor-generator 16 can output power for driving use.

Further, the second motor-generator 16 is electrically connected to the PCU 18. At the time of deceleration of the vehicle 1, due to rotation of the wheels 36, the second motor-generator 16 is driven and the second motor-generator 16 functions as a generator. As a result, so-called regeneration is performed. When the second motor-generator 16 functions as a generator, the regenerative power generated by the second motor-generator 16 is supplied through the PCU 18 to the battery 20. On the other hand, when the second motor-generator 16 functions as a motor, the power stored in the battery 20 is supplied through the PCU 18 to the second motor-generator 16.

The PCU 18 is electrically connected to the first motor-generator 12, second motor-generator 16, and battery 20. The PCU 18 includes an inverter, a booster converter, and a DC-DC converter. The inverter converts DC power supplied from the battery 20 to AC power and converts AC power generated by the first motor-generator 12 or second motor-generator 16 to DC power. The booster converter boosts the voltage of the battery 20 in accordance with need when the power stored in the battery 20 is supplied to the first motor-generator 12 or the second motor-generator 16. The DC-DC converter lowers the voltage of the battery 20 when the electric power stored in the battery 20 is supplied to the headlights or other electronic equipment.

The battery 20 is supplied with the electric power generated by the first motor-generator 12 using the output of the internal combustion engine 10 and the regenerative electric power generated by the second motor-generator 16 using the regenerative energy. Therefore, the battery 20 can be charged by the output of the internal combustion engine 10 and the regenerative energy. The battery 20 is for example a lithium ion battery, nickel hydrogen battery, or other secondary battery.

The vehicle 1 is further provided with a charging port 22 and charger 24. The battery 20 can be charged by an external power source 70 as well. Therefore, the vehicle 1 is a so-called “plug-in hybrid vehicle”.

The charging port 22 is configured so as to receive the electric power from the external power source 70 through a charging connector 74 of a charging cable 72. When the battery 20 is charged by the external power source 70, the charging connector 74 is connected to the charging port 22. The charger 24 converts the electric power supplied from the external power source 70 to electric power which can be supplied to the battery 20. Note that, the charging port 22 may also be connected to the PCU 18, and the PCU 18 may also function as the charger 24.

<Control Device of Hybrid Vehicle>

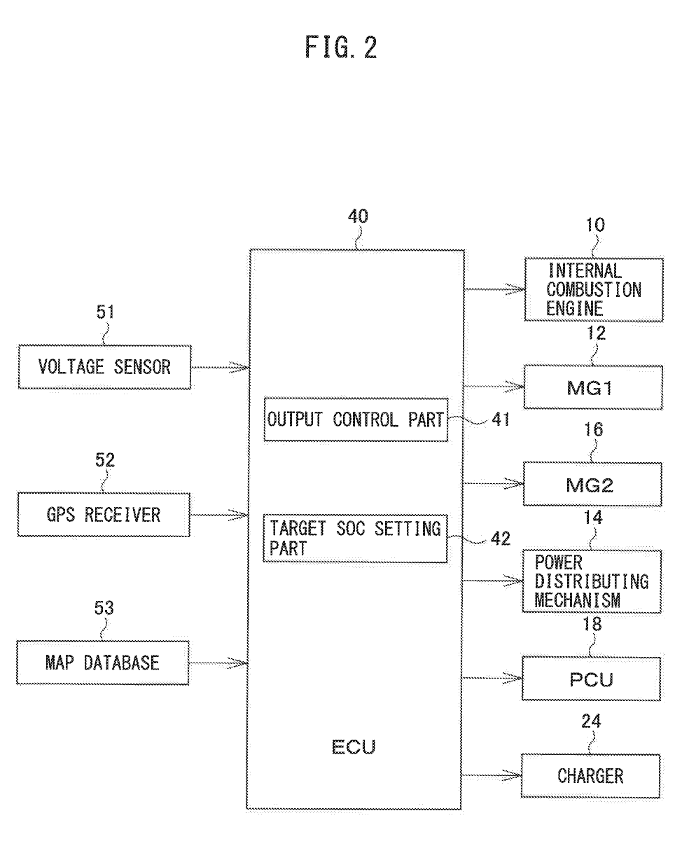

FIG. 2 is a block diagram schematically showing the configuration of a control device etc., of a hybrid vehicle according to a first embodiment of the present invention. The vehicle 1 is provided with an electronic control unit (ECU) 40. The ECU 40 is an electronic control device controlling the vehicle 1. The ECU 40 is provided with a read only memory (ROM) and random access memory (RAM) or other such memory, a central processing unit (CPU), input port, output port, communication module, etc. In the present embodiment, a single ECU 40 is provided, but a plurality of ECUs may be provided for the different functions.

The outputs of various sensors provided at the vehicle 1 are input to the ECU 40. For example, in the present embodiment, the outputs of a voltage sensor 51 and a GPS receiver 52 are input to the ECU 40.

The voltage sensor 51 is provided at the battery 20 and detects the voltage across the electrodes of the battery 20. The voltage sensor 51 is connected to the ECU 40, so the output of the voltage sensor 51 is transmitted to the ECU 40.

The GPS receiver 52 receives signals from three or more GPS satellites and detects the current position of the vehicle 1 (for example, the longitude and latitude of the vehicle 1). The GPS receiver 52 is connected to the ECU 40, so the output of the GPS receiver 52 is transmitted to the ECU 40.

Further, in the present embodiment, the ECU 40 is connected to a map database 53 provided at the vehicle 1. The map database 53 is a database relating to the map information. The map information includes positional information of roads, shape information of roads (for example curved or straight, the radius of curvature of curves, the road grade, etc.), the types of roads, and other information. The ECU 40 acquires map information from the map database 53. Note that, when a navigation system is provided at the vehicle 1, the map database 53 may be a part of the navigation system.

The ECU 40 is connected to the internal combustion engine 10, first motor-generator 12, second motor-generator 16, power distributing mechanism 14, PCU 18, and charger 24 and controls these. In the present embodiment, the ECU 40 runs programs etc., stored in the memory and thereby functions as an output control part 41 and a target state-of-charge setting part (a target SOC setting part) 42.

The output control part 41 controls the outputs of the internal combustion engine 10, first motor-generator 12, and second motor-generator 16. Specifically, the output control part 41 switches the driving mode of the vehicle 1 between the EV mode and the HV mode. In the EV mode and HV mode, it controls the outputs of the internal combustion engine 10, first motor-generator 12, and second motor-generator 16. The EV mode is a driving mode with a relatively small ratio of the operating time of the internal combustion engine to the driving time of the vehicle 1 (the time when ignition switch is on), while the HV mode is a driving mode with a relatively large ratio.

The vehicle 1 roughly has three drive states. In a first drive state, the internal combustion engine 10 is stopped and the power for driving use is output by only the second motor-generator 16. In the first drive state, the battery 20 is not charged by output of the internal combustion engine 10 and electric power is supplied to the second motor-generator 16 from the battery 20. Note that, if a one-way clutch transmitting rotational force only in one direction is provided at the power distributing mechanism 14, it is possible to output power for driving use by both the first motor-generator 12 and second motor-generator 16. In this case, in the first drive state, the internal combustion engine 10 is stopped and the power for driving use is output by the second motor-generator 16 or the first motor-generator 12 and second motor-generator 16.

In a second drive state, the internal combustion engine 10 is operated and the output of the internal combustion engine 10 is used to charge the battery 20. In the second drive state, the power for driving use is output by the internal combustion engine 10, while the electric power generated using a part of the output of the internal combustion engine 10 is supplied to the battery 20. Note that, in the second drive state, the electric power may be supplied to the second motor-generator 16 and the second motor-generator 16 may output power for driving use.

In a third drive state, the internal combustion engine 10 is operated, but the output of the internal combustion engine 10 is not used to charge the battery 20. In the third drive state, the electric power generated using a part of the output of the internal combustion engine 10 is supplied to the second motor-generator 16, whereby power for driving use is output by the internal combustion engine 10 and second motor-generator 16. Note that, in the third drive state, electric power may be supplied from the battery 20 to the second motor-generator 16.

In the EV mode, the drive state of the vehicle 1 is constantly maintained at the first drive state. That is, in the EV mode, the internal combustion engine 10 is constantly stopped. On the other hand, in the HV mode, the drive state of the vehicle 1 is switched among the first drive state, second drive state, and third drive state according to the vehicle speed, state of charge (SOC) of the battery 20, driver demanded output, and other conditions. Therefore, the EV mode is a driving mode with a relatively large degree of reduction of the SOC of the battery 20, while the HV mode is a driving mode with a relatively small degree of reduction of the SOC of the battery 20.

The target SOC setting part 42 sets the target SOC which is a target value of the SOC of the battery 20. Specifically, the target SOC setting part 42 sets the target SOC so that the SOC of the battery 20 becomes the arrival SOC when the vehicle 1 reaches a predetermined charging location. The arrival SOC is the target value of the SOC of the battery 20 when the vehicle 1 reaches the predetermined charging location. The target SOC is set so that the driving mode is maintained at the EV mode from the current location of the vehicle 1 to the charging location. By doing this, the driving time of the internal combustion engine 10 can be shortened.

If driving the vehicle 1 from the current location to the charging location by only the EV mode, the amount of electric power required until reaching the charging location becomes greater the longer the distance from the current location to the charging location. For this reason, the target SOC setting part 42 calculates the amount of electric power required for making the vehicle 1 reach the charging location by the EV mode and adds the SOC corresponding to the required amount of electric power to the arrival SOC to thereby calculate the target SOC.

When the vehicle 1 is being driven outside the charging location, the output control part 41 controls the outputs of the internal combustion engine 10, first motor-generator 12, and second motor-generator 16 so that the SOC of the battery 20 when the vehicle 1 reaches the charging location becomes the arrival SOC. Therefore, when the vehicle 1 is being driven outside the charging location, the output control part 41 controls the outputs of the internal combustion engine 10, first motor-generator 12, and second motor-generator 16 so that the SOC of the battery 20 becomes equal to or more than the target SOC. Specifically, the output control part 41 sets the driving mode of the vehicle 1 to the EV mode when the current SOC is equal to or more than the target SOC and sets the driving mode of the vehicle 1 to the HV mode when the current SOC is less than the target SOC.

The driver of the vehicle 1 often utilizes a plurality of charging locations for charging the battery 20 (home, parking lot where external power source 70 is provided, charging station, etc.). If there are a plurality of charging locations, the amount of electric power required for making the vehicle 1 reach a charging location by the EV mode is calculated for every charging location.

Further, the charging locations utilized by the vehicle 1 are successively registered in accordance with the states of utilization of the external power sources 70 of the charging locations. For example, if the battery 20 is charged for the first time by the external power source 70 at a predetermined location, that position is registered as a charging location. The positional information is detected by the GPS receiver 52.

Whether the battery 20 is charged is judged based on the SOC of the battery 20. For example, if the SOC rose when the internal combustion engine 10 was stopped, it is judged that the battery 20 was charged. Note that, whether the battery 20 is charged may be judged by detecting by a sensor etc., that the charging connector 74 is connected to the charging port 22.

Further, if the vehicle 1 is provided with a navigation system, a charging location may be registered on map data of the navigation system. In this case, the charging location may be registered by the driver himself. Further, charging locations present on the map data and within a predetermined distance from one's home may be registered in advance as charging locations to be utilized by the driver. The registered information of the charging locations is stored in the ECU 40.

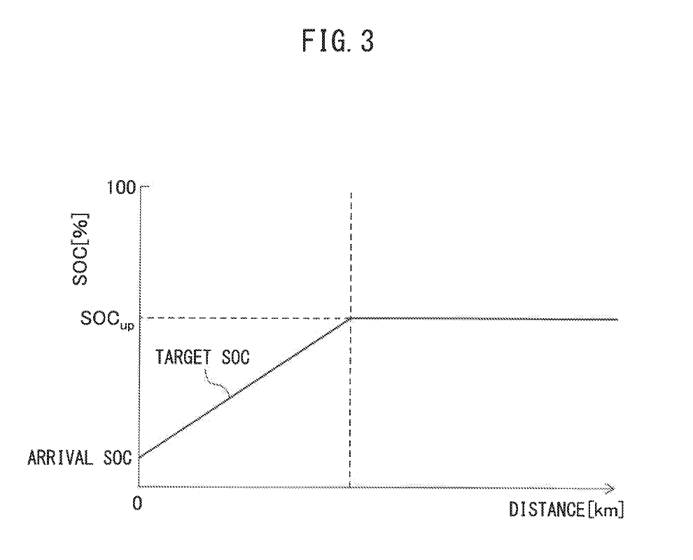

FIG. 3 is a view schematically showing the relationship between the distance to a charging location and the target SOC. As shown in FIG. 3, the target SOC is set to the arrival SOC when the distance to the charging location is zero and is made higher the longer the distance to the charging location. However, if the SOC becomes too high, it is not possible to charge the battery 20 by the regenerative electric power obtained on a long downhill slope etc., and the regenerative electric power becomes wasted. For this reason, for the target SOC, the upper limit value SOCup is set.

As explained above, in the vehicle 1, it is possible to charge the battery 20 by an external power source 70. In this case, when the vehicle 1 reaches a charging location at which an external power source 70 is provided, the SOC of the battery 20 is preferably as low as possible. By doing this, it is possible to make the operating time of the internal combustion engine 10 the minimum and in turn possible to improve the fuel efficiency and exhaust emission of the vehicle 1. Further, if the battery 20 is charged by the external power source 70 at the charging location, the SOC of the battery 20 is restored. For this reason, when the vehicle 1 is again driven, the operating mode can be set to the EV mode.

Therefore, the arrival SOC is preferably set to as low a value as possible. However, the driver of the vehicle 1 changes the destination while driving according to the circumstance. For this reason, even if the vehicle 1 is being driven near a charging location, sometimes the hybrid vehicle will not be stopped at the charging location.

When the arrival SOC is set to substantially zero, if the vehicle 1 bypasses the charging location, the vehicle 1 cannot use the electric power of the battery 20 much at all. In this case, it is not possible to use the first motor-generator 12 and second motor-generator 16 as sources of power for driving use or it is necessary to limit the outputs of the first motor-generator 12 and second motor-generator 16. As a result, the power performance of the vehicle 1 falls. In particular, when the vehicle 1 bypasses a charging location, then is driven over an uphill slope, if the maximum output of the internal combustion engine 10 is smaller than the maximum outputs of the first motor-generator 12 and second motor-generator 16 etc., the output for driving use becomes insufficient compared with the driver demanded output and the drop in power performance becomes remarkable.

Therefore, in the present embodiment, the target SOC setting part 42 sets the target SOC based on the amount of electric power required for making the vehicle 1 reach a charging location by the EV mode, that is, the amount of electric power required for the vehicle 1 to reach the charging location by only the outputs of the first motor-generator 12 and second motor-generator 16, and the grade information of the roads near the charging location. By doing this, it is possible to set the target SOC to a suitable value corresponding to the grade information of the roads near the charging location. Therefore, it is possible to shorten the driving time of the internal combustion engine 10 while suppressing the drop of the power performance of the vehicle 1.

Specifically, the target SOC setting part 42 raises the arrival SOC when there is an uphill slope near a charging location compared to when there is no uphill slope near the charging location. By doing this, even if the vehicle 1 is being driven over an uphill slope after bypassing the charging location, since the arrival SOC is high, it is possible to secure the power performance when being driven over the uphill slope by the remaining SOC. Further, when there is no uphill slope near the charging location, it is possible to lower the target SOC and possible to lengthen the driving time of the vehicle 1 by the EV mode. Therefore, it is possible to shorten the driving time of the internal combustion engine 10 while suppressing the drop of the power performance of the vehicle 1.

Further, the SOC of the battery 20 is restored by the regenerative electric power if the vehicle 1 bypasses a charging location, then is driven over a downhill slope. In this case, even if the vehicle 1 continues being driven, a drop in the power performance is suppressed. For this reason, the target SOC setting part 42 lowers the arrival SOC when there is a downhill slope near the charging location compared with when there is no downhill slope near the charging location. By doing this as well, it is possible to shorten the driving time of the internal combustion engine 10 while suppressing the drop of the power performance of the vehicle 1.

<Processing for Calculation of Arrival SOC>

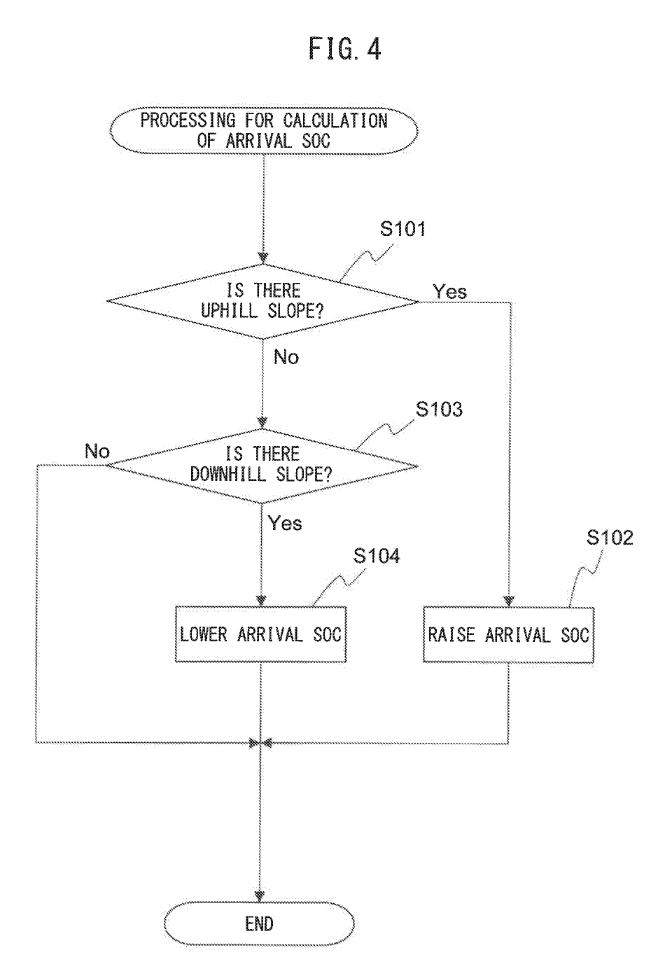

FIG. 4 is a flow chart showing a control routine of processing for calculation of the arrival SOC in the first embodiment of the present invention. In the present control routine, the arrival SOC is calculated. The present control routine is performed for each registered charging location and is performed by the ECU 40.

First, at step S101, the target SOC setting part 42 judges whether there is an uphill slope near a charging location. Specifically, the target SOC setting part 42 judges whether there is an uphill slope near the charging location based on map information of the map database 53. “Near the charging location” is for example defined as a range of a predetermined distance or less from the charging location. Further, an “uphill slope” is, for example, defined as a road with a predetermined value or more of positive grade continuing for a predetermined distance or more.

Note that, “near the charging location” may be defined as a range in which an SOC required for enabling the vehicle 1 to reach the charging location by the EV mode is within a predetermined value. The required SOC is calculated based on the distance to the charging location, grade information and driving history (mean vehicle speed etc.) of the route to the charging location, and the like. Further, “near the charging location” may be defined as a range in which a driving time of the vehicle 1 to the charging location is within a predetermined time The driving time until the charging location is calculated based on the distance to the charging location, a driving history of a route to the charging location (required time etc.), and the like.

If at step S101 it is judged there is an uphill slope near a charging location, the present control routine proceeds to step S102. At step S102, the target SOC setting part 42 corrects the arrival SOC. Specifically, the target SOC setting part 42 increases the arrival SOC from the initial value. The initial value of the arrival SOC is predetermined and, for example, is set to 25%. Note that, the initial value of the arrival SOC may be set to a value different for each charging location based on a frequency by which the vehicle 1 is stopped at a charging location when it is being driven near the charging location.

Further, as shown in FIG. 3, the target SOC basically becomes lower the shorter the distance until the charging location. For this reason, if the arrival SOC is constant, the degree of reduction of power performance when the vehicle 1 bypasses the charging location and is being driven on an uphill slope becomes larger the shorter the distance from the charging location to the uphill slope.

For this reason, the target SOC setting part 42 raises the arrival SOC the shorter the distance from the charging location to an uphill slope. By doing this, it is possible to more effectively shorten the operating time of the internal combustion engine 10 while keeping the power performance of the vehicle 1 from dropping. Note that, the target SOC setting part 42 may raise the arrival SOC the shorter the driving time of the vehicle 1 from the charging location to an uphill slope. The driving time of the vehicle 1 from the charging location to an uphill slope is calculated based on the distance from the charging location to an uphill slope, a driving history of a route from the charging location to an uphill slope (required time etc.), and the like.

Further, it is necessary to raise the SOC of the battery 20 when the vehicle 1 reaches an uphill slope the larger the amount of electric power of the battery 20 consumed on an uphill slope. For this reason, the target SOC setting part 42 raises the arrival SOC the larger the amount of electric power of the battery 20 consumed on an uphill slope. By doing this, it is possible to more effectively shorten the operating time of the internal combustion engine 10 while keeping the power performance of the vehicle 1 from falling. The amount of electric power of the battery 20 consumed on an uphill slope is calculated based on the driving history of the vehicle 1 on the uphill slope (amount of drop of electric power of battery 20 etc.).

Further, the amount of electric power of the battery 20 consumed on an uphill slope becomes larger the larger the grade of the uphill slope. For this reason, the target SOC setting part 42 may increase the arrival SOC the larger the grade of the uphill slope. Further, the longer the uphill slope, the larger the amount of electric power of the battery 20 consumed on the uphill slope. For this reason, the target SOC setting part 42 may increase the arrival SOC the longer the uphill slope.

Further, when the frequency of the vehicle 1 being driven over an uphill slope when being driven near a charging location is low, the possibility of the vehicle 1 being driven over an uphill slope after bypassing near the charging location is low. For this reason, the target SOC setting part 42 decreases the arrival SOC the lower the frequency of the vehicle 1 being driven over an uphill slope when being driven near a charging location. For example, the target SOC setting part 42 calculates the frequency of the vehicle 1 being driven over an uphill slope when being driven near a charging location as the ratio of the vehicle 1 being driven over an uphill slope when starting from the charging location and being driven away from the charging location by a predetermined distance or more in the past.

If there are a plurality of uphill slopes near the charging location, the target SOC setting part 42 calculates a corrected arrival SOC for each uphill slope and sets the highest arrival SOC to the final arrival SOC. By doing this, even when the vehicle 1 bypasses a charging location, then is driven over an uphill slope of the severest condition, it is possible to effectively suppress a drop in the power performance of the vehicle 1. Note that, if there are a plurality of uphill slopes near the charging location, the target SOC setting part 42 may calculate the corrected arrival SOC only for the uphill slope closest to the charging location.

After step S102, the present control routine ends. On the other hand, if at step S101 it is judged that there is no uphill slope near a charging location, the present control routine proceeds to step S103. At step S103, the target SOC setting part 42 judges whether there is a downhill slope near the charging location. Specifically, the target SOC setting part 42 judges whether there is a downhill slope near the charging location based on the map information of the map database 53. A “downhill slope” is defined, for example, as a road with a predetermined value or less of a negative grade continuing for a predetermined distance or more.

If at step S103 it is judged that there is a downhill slope near a charging location, the present control routine proceeds to step S104. At step S104, the target SOC setting part 42 corrects the arrival SOC. Specifically, the target SOC setting part 42 lowers the arrival SOC from the initial value. After step S104, the present control routine ends.

Further, if at step S103 it is judged that there is no downhill slope near the charging location, the present control routine ends. In this case, the arrival SOC is maintained at the initial value.

Note that, the target SOC setting part 42 may lower the arrival SOC from the initial value only if the surroundings of a charging location are all downhill slopes. Further, the target SOC setting part 42 may lower the arrival SOC from the initial value only when the frequency by which the vehicle 1 is driven over a downhill slope near the charging location when being driven near the charging location is equal to or more than a predetermined value. Further, step S101 and step S102 or step S103 and step S104 may be omitted.

<Processing for Calculation of Target SOC>

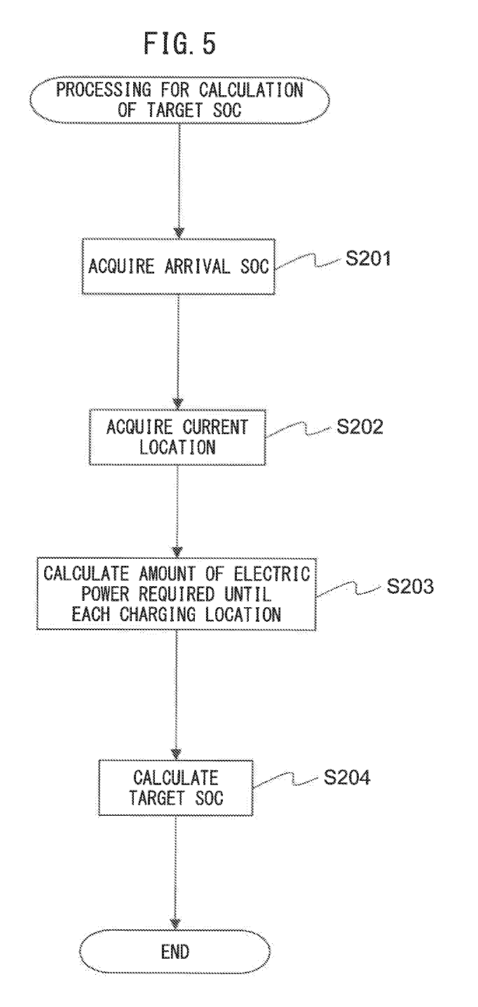

FIG. 5 is a flow chart showing a control routine of processing for calculation of the target SOC in the first embodiment of the present invention. In the present control routine, the target SOC is calculated. The present control routine is performed repeatedly by the ECU 40 at predetermined time intervals.

First, at step S201, the target SOC setting part 42 acquires the arrival SOC of each charging location. The arrival SOC of each charging location is calculated at the control routine of processing for calculation of the arrival SOC of FIG. 4. Next, at step S202, the target SOC setting part 42 acquires the current location of the vehicle 1. The current location of the vehicle 1 is detected by the GPS receiver 52.

Next, at step S203, the target SOC setting part 42 calculates the amount of electric power required for making the vehicle 1 reach each charging location from the current location by the EV mode. The required amount of electric power is calculated based on the distance from the current location to the charging location, the grade information and driving history (mean vehicle speed etc.) of the route to the charging location, the current vehicle speed, etc.

Next, at step S204, the target SOC setting part 42 calculates the target SOC. Specifically, the target SOC setting part 42 calculates the target SOC for each charging location and sets the minimum value of the target SOC to the final target SOC. The target SOC for each charging location is calculated by adding SOC corresponding to the required amount of electric power calculated at step S203 to the arrival SOC. Note that, if a predetermined charging location is input to the navigation system as a destination, only the target SOC of the charging location may be calculated. After step S204, the present control routine ends.

<Processing for Setting Driving Mode>

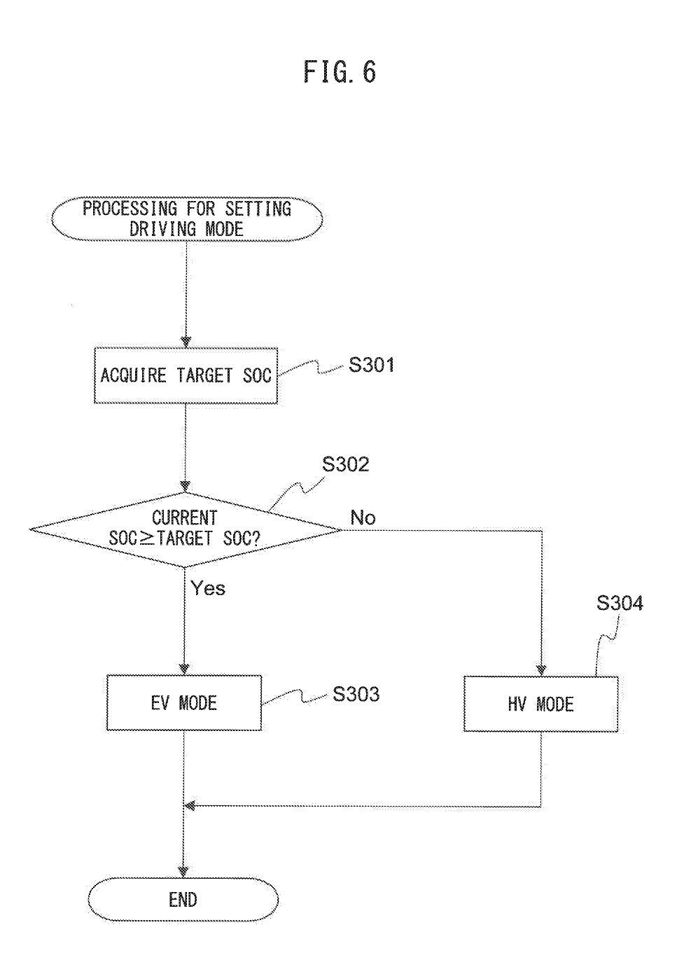

FIG. 6 is a flow chart showing a control routine of processing for setting a driving mode in the first embodiment of the present invention. In the present control routine, the driving mode of the vehicle 1 is set. The present control routine is performed repeatedly by the ECU 40 at predetermined time intervals.

First, at step S301, the output control part 41 acquires the target SOC. The target SOC is calculated in the control routine of the processing for calculation of the target SOC of FIG. 5. Next, at step S302, the output control part 41 judges whether the current SOC is equal to or more than the target SOC. The current SOC is calculated based on the output of the voltage sensor 51 etc.

If at step S302 it is judged that the current SOC is equal to or more than the target SOC, the present control routine proceeds to step S303. At step S303, the output control part 41 sets the driving mode of the vehicle 1 to the EV mode. After step S303, the present control routine ends.

On the other hand, if at step S302 it is judged that the current SOC is less than the target SOC, the present control routine proceeds to step S304. At step S304, the output control part 41 sets the driving mode of the vehicle 1 to the HIV mode. After step S304, the present control routine ends.

Note that, to suppress frequent switching between the EV mode and the HV mode, at step S304, the driving mode may be maintained at the HV mode until the current SOC reaches a value higher than the target SOC (for example, target SOC+several %). Further, when the driver demanded output is equal to or more than a predetermined value and it is demanded that the internal combustion engine 10 also should output power for driving use, the driving mode of the vehicle 1 is switched from the EV mode to the HV mode even if the current SOC is equal to or more than the target SOC.

### Second Embodiment

The control device of a hybrid vehicle according to a second embodiment is basically similar in configuration and control of a control device of a hybrid vehicle according to the first embodiment except for the points explained below. For this reason, below, the second embodiment of the present invention will be explained centered on the parts different from the first embodiment.

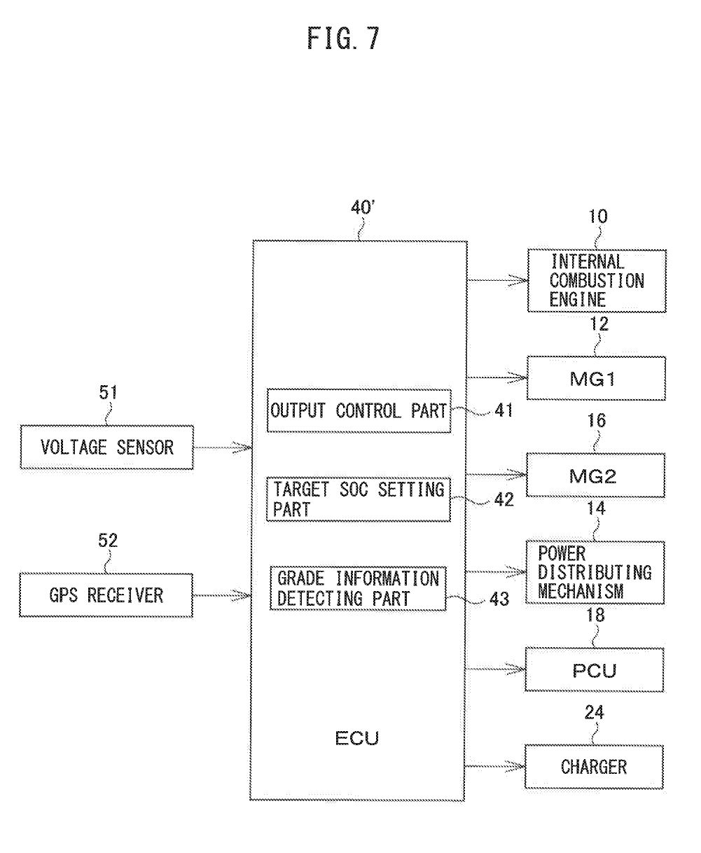

FIG. 7 is a block diagram schematically showing the configuration of the control device etc., of the hybrid vehicle according to the second embodiment of the present invention. In the second embodiment, the ECU 40′ runs programs etc., stored in the memory and thereby functions as an output control part 41, an target SOC setting part 42, and an grade information detecting part 43.

The grade information detecting part 43 detects the grade information of the roads near a charging location based on the driving history of the vehicle 1. By doing this, even if the vehicle 1 is not provided with a map database, it is possible to detect the grade information of the roads near the charging location (below, simply referred to as the “grade information”).

For example, the grade information detecting part 43 detects the grade information based on fluctuation of the amount of electric power of the battery 20 when the vehicle 1 is being driven near a charging location. Specifically, the grade information detecting part 43 judges that the location is an uphill slope when the vehicle 1 is being driven near the charging location and a degree of reduction of the amount of electric power of the battery 20 is equal to or more than a predetermined value for a predetermined time or more. The positional information of the uphill slope is detected by the GPS receiver 52. Further, the grade information detecting part 43 can also detect the amount of electric power of the battery 20 consumed at the uphill slope, a grade of the uphill slope, and a length of the uphill slope based on a degree of reduction of the amount of electric power of the battery 20 when the vehicle 1 is being driven near the charging location. Various information on the uphill slope is stored in the ECU 40.

Further, if the vehicle 1 is being driven over a downhill slope, the amount of electric power of the battery 20 is increased by the regenerative electric power. For this reason, the grade information detecting part 43 judges that the location is a downhill slope if the degree of increase of the amount of electric power of the battery 20 is equal to or more than a predetermined value for a predetermined time or more when the vehicle 1 is being driven near a charging location. The positional information of the downhill slope is detected by the GPS receiver 52 and is stored in the ECU 40.

Note that, the grade information detecting part 43 may detect the grade information based on the driver demanded output or the power for driving use when the vehicle 1 is being driven near a charging location. Specifically, the grade information detecting part 43 judges that the location is an uphill slope when the vehicle 1 is being driven near the charging location and the driver demanded output or the power for driving use is equal to or more than a predetermined value for a predetermined time or more. Further, the grade information detecting part 43 judges that the location is a downhill slope when the vehicle 1 is being driven near the charging location and the driver demanded output or the power for driving use is substantially zero for a predetermined time or more. Further, if the GPS receiver 52 can detect the grade information, the grade information detecting part 43 may use the GPS receiver 52 to detect the grade information.

If detecting the grade information based on the actual driving of the vehicle 1, there is the possibility of there being an uphill slope on a not yet traveled road. For this reason, if lowering the target SOC before the grade information finishes being detected, the vehicle 1 is liable to bypass the charging location, then run along the undetected uphill slope and fall in power performance.

Therefore, in the second embodiment, the target SOC setting part 42 lowers the target SOC if the grade information detecting part 43 finishes detecting the grade information and does not detect an uphill slope near the charging location. By doing this, it is possible to suppress the drop in power performance on a nondetected uphill slope.

<Processing for Calculation of Arrival SOC>

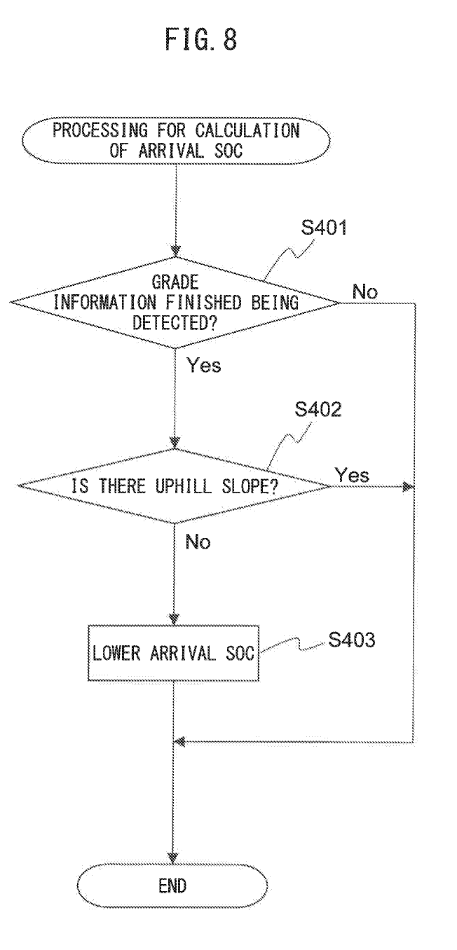

FIG. 8 is a flow chart showing a control routine of processing for calculation of the arrival SOC in the second embodiment of the present invention. In the present control routine, the arrival SOC is calculated. The present control routine is performed for every registered charging location and is performed by the ECU 40.

First, at step S401, the target SOC setting part 42 judges whether the grade information has finished being detected by the grade information detecting part 43. For example, the target SOC setting part 42 judges that the grade information has finished being detected when the grade information detecting part 43 grasps the surrounding environment of a charging location by actual driving of the vehicle 1.

The driver of the vehicle 1 often selects the same route when heading from a charging location to a destination in a predetermined direction. For this reason, the grade information detecting part 43 judges that the surrounding environment of the charging location has been grasped if the vehicle 1 starts from the charging location and separates from the charging location by a predetermined distance or more in a plurality of directions.

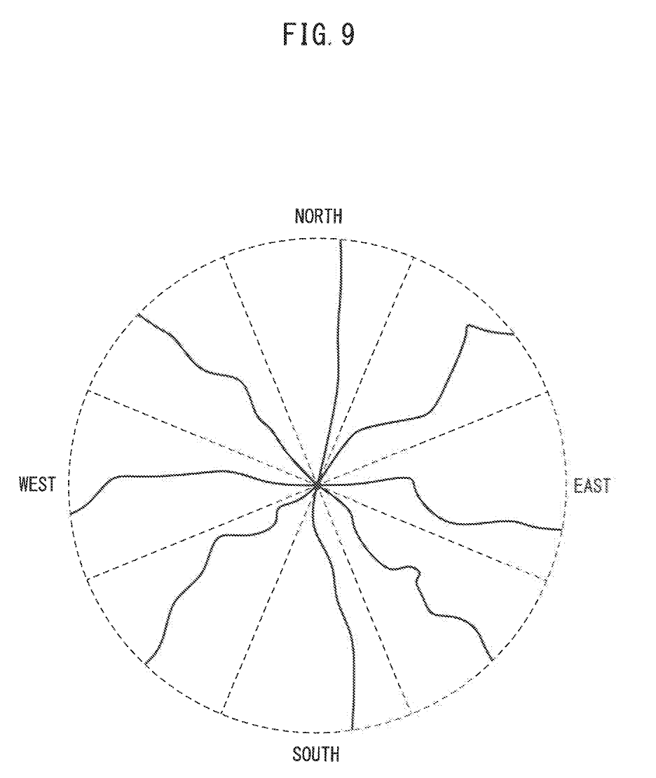

FIG. 9 is a view showing a driving path of the vehicle 1 near a charging location. The center of the circle of FIG. 9 shows the position of the charging location (for example one's own home). In the example of FIG. 9, the region near the charging location surrounded by the circle is divided into eight divided regions. The grade information detecting part 43 judges that the surrounding environment of the charging location has been grasped when the vehicle 1 starts from the charging location and is driven a predetermined distance or more from the charging location in eight directions (eight divided regions). Note that, the number of divided regions may be other numbers (4, 6, 10, etc.). Further, the grade information detecting part 43 may judge that the surrounding environment of the charging location is grasped when the number of times that the vehicle 1 starts from the charging location and drives away from the charging location by a predetermined distance or more reaches a predetermined number.

If at step S401 it is judged that the grade information has not finished being detected, the present control routine ends. In this case, the arrival SOC is maintained at the initial value. Note that, in the second embodiment, the initial value of the arrival SOC is set to a value enabling suppression of the drop of power performance of the vehicle 1 on an uphill slope (for example 25 to 40%).

On the other hand, if at step S401 it is judged that the grade information has finished being detected, the present control routine proceeds to step S402. At step S402, the target SOC setting part 42 judges whether there is an uphill slope near the charging location. The uphill slope is detected by the grade information detecting part 43.

If at step S402 it is judged that there is an uphill slope near the charging location, the present control routine ends. In this case, the arrival SOC is maintained at the initial value. Note that, in the same way as the first embodiment, the target SOC setting part 42 may change the arrival SOC from the initial value based on the distance from the charging location to the uphill slope, a driving time from the charging location to the uphill slope, an amount of electric power of the battery 20 consumed on the uphill slope, a grade of the uphill slope, a length of the uphill slope, or a frequency of the vehicle 1 being driven on the uphill slope when driving near the charging location.

On the other hand, if at step S402 it is judged that there is no uphill slope near the charging location, the present control routine proceeds to step S403. At step S403, the target SOC setting part 42 lowers the arrival SOC from the initial value. After step S403, the present control routine ends.

Note that, at step S403 the target SOC setting part 42 may increase the amount of decrease of the arrival SOC if there is a downhill slope near the charging location compared to if there is no downhill slope near the charging location.

In the second embodiment as well, the control routine of the processing for calculation of the target SOC of FIG. 5 and the control routine of processing for setting the driving mode of FIG. 6 are performed. At step S201 of FIG. 5, the arrival SOC of each charging location calculated at the control routine of the processing for calculation of the arrival SOC of FIG. 8 is acquired.

### Third Embodiment

The control device of a hybrid vehicle according to a third embodiment is basically similar in configuration and control of a control device of a hybrid vehicle according to the first embodiment except for the points explained below. For this reason, below, the third embodiment of the present invention will be explained centered on the parts different from the first embodiment.

In the third embodiment as well, the target SOC setting part 42 sets the target SOC based on the amount of electric power required for making the vehicle 1 reach a charging location by the EV mode, that is, the amount of electric power required for making the vehicle 1 reach a charging location by the outputs of only the first motor-generator 12 and second motor-generator 16 (below, referred to as the “necessary amount of electric power”) and the grade information. Specifically, if there is an uphill slope near the charging location, the target SOC setting part 42 calculates the first target SOC based on the necessary amount of electric power, calculates the second target SOC based on the amount of electric power chargeable to the battery 20 by the output of the internal combustion engine 10 from the current location of the vehicle 1 to the uphill slope (below, referred to as the “chargeable amount of electric power”), and sets the target SOC to a higher value of the first target SOC and second target SOC.

Therefore, the target SOC setting part 42 sets the target SOC to the first target SOC when the first target SOC is equal to or more than the second target SOC and sets the target SOC to the second target SOC when the first target SOC is less than the second target SOC. By doing this, if there is an uphill slope near the charging location, it is possible to set the target SOC to a suitable value and possible to shorten the driving time of the internal combustion engine 10 while suppressing the drop of the power performance of the vehicle 1.

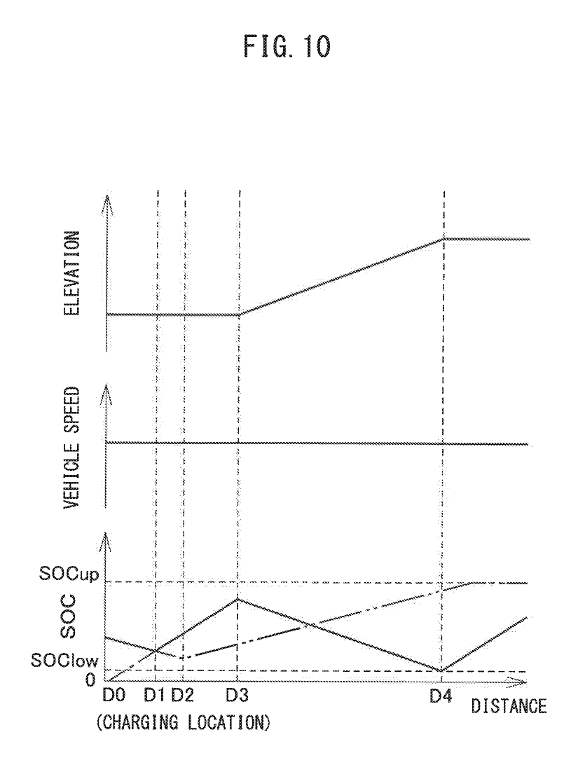

FIG. 10 is a view showing an example of setting a target SOC in the third embodiment. FIG. 10 shows an elevation of the road being driven on, a speed of the vehicle 1 (vehicle speed), and a change of the SOC of the battery 20. In the graph of the SOC of the battery 20, the actual SOC is shown by a solid line, the first target SOC is shown by a two-dot chain line, and the second target SOC is shown by a one-dot chain line.

In the example of FIG. 10, the vehicle 1 bypasses a charging location, then is driven on an uphill slope. The distance D2 corresponds to the charging location, the distance D3 corresponds to a starting point of the uphill slope, and the distance D4 corresponds to an end point of the uphill slope. Further, in the example of FIG. 10, the vehicle speed is maintained constant.

The first target SOC is calculated by adding the SOC corresponding to the necessary amount of electric power to the arrival SOC at the charging location. For this reason, from the distance D0 to the distance D2, the first target SOC gradually becomes lower the closer to the charging location. At the distance D2 on, it gradually becomes higher the further from the charging location. Further, if the first target SOC reaches the upper limit value SOCup of the target SOC, the first target SOC is maintained at the upper limit value SOCup.

The second target SOC is set so that the SOC of the battery 20 reaches a predetermined value at the starting point of the uphill slope by charging the battery 20 using the output of the internal combustion engine 10. For this reason, the second target SOC is calculated by subtracting the chargeable amount of electric power from the target value of the SOC at the starting point of the uphill slope (below, referred to as the “starting point SOC”). Further, the second target SOC is set to zero while being driven along an uphill slope. For this reason, the second target SOC becomes higher the closer to the starting point of the uphill slope from the distance D0 to the distance D3 and is set to zero from the distance D3 to the distance D4 while being driven along the uphill slope. Further, in this example, the distance between the distance D4 and the distance D3 is long, so at the distance D4 on as well, the second target SOC is set to zero.

In the example of FIG. 10, from the distance D0 to the distance D1, the first target SOC is equal to or more than the second target SOC, so the target SOC is set to the first target SOC. On the other hand, from the distance D1 to the distance D3, the second target SOC is higher than the first target SOC, so the target SOC is set to the second target SOC. Further, at the distance D3 on, the first target SOC is equal to or more than the second target SOC, so the target SOC is set to the first target SOC.

The actual SOC changes along the target SOC from the distance D0 to the distance D3. At the distance D1, the operating mode of the vehicle 1 is switched from the EV mode to the HV mode, while the battery 20 is charged by the output of the internal combustion engine 10 from the distance D2 to the distance D3. On the other hand, the electric power of the battery 20 is consumed for being driven on an uphill slope from the distance D3 to the distance D4, so the actual SOC gradually falls regardless of the target SOC. Further, at the distance D4 on, the charging of the battery 20 by the output of the internal combustion engine 10 is resumed and the actual SOC gradually becomes higher toward the target SOC.

In the example of FIG. 10, the actual SOC reaches the lower limit value SOClow at the end point of the uphill slope. Therefore, the starting point SOC is set so that the actual SOC becomes the lower limit value SOClow at the end point of the uphill slope. The lower limit value SOClow is the lower limit value of the range of actual use of the battery 20 and is predetermined considering the deterioration of the battery 20 etc. Note that, even if the actual SOC reaches the lower limit value SOClow before the end point of the uphill slope, it is possible to suppress the drop in power performance on the uphill slope if the actual SOC at the starting point of the uphill slope can be made higher than the first target SOC.

<Processing for Setting Target SOC>

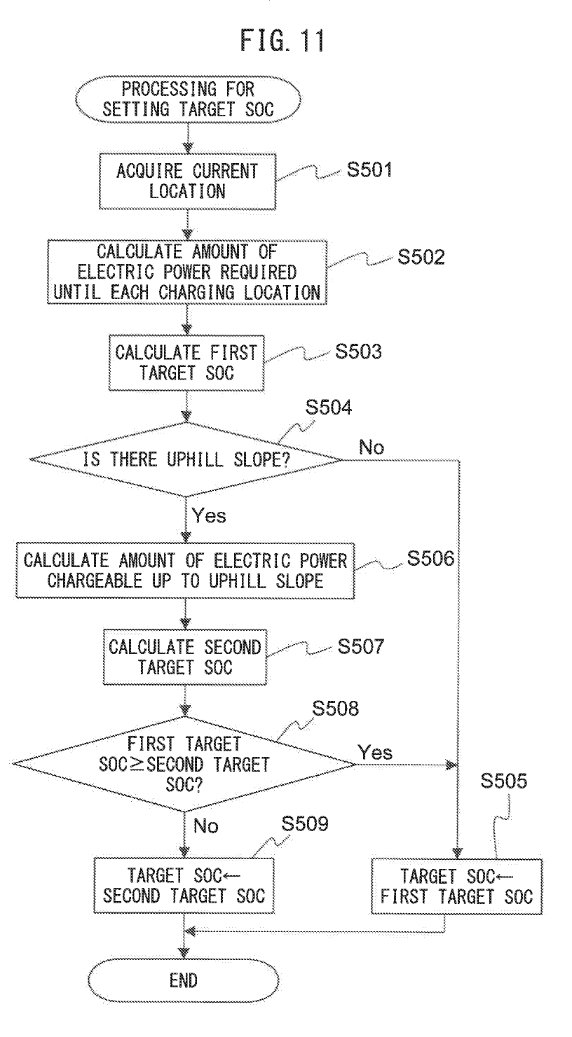

FIG. 11 is a flow chart showing the control routine of processing for setting the target SOC in the third embodiment of the present invention. In the present control routine, the target SOC is set. The present control routine is repeatedly performed by the ECU 40 at predetermined time intervals.

First, at step S501, in the same way as step S202 of FIG. 5, the target SOC setting part 42 acquires the current location of the vehicle 1. Next, at step 502, in the same way as step S203 of FIG. 5, the target SOC setting part 42 calculates the amount of electric power required for making the vehicle 1 reach each charging location from a current location by the EV mode.

Next, at step S503, the target SOC setting part 42 calculates the first target SOC based on a preset arrival SOC (for example 10 to 25%). Specifically, the target SOC setting part 42 calculates the first target SOC for every charging location and sets the minimum value of the first target SOC to the final first target SOC. The first target SOC for every charging location is calculated by adding the SOC corresponding to the required amount of electric power calculated at step S502 to the arrival SOC. Note that, the arrival SOC may be set to a value different for each charging location based on the frequency of the vehicle 1 being stopped at a charging location when being driven near the charging location.

Next, at step S504, in the same way as step S101 of FIG. 4, the target SOC setting part 42 judges whether there is an uphill slope near the charging location. If it is judged that there is no uphill slope near the charging location, the present control routine proceeds to step S505. At step S505, the target SOC setting part 42 sets the target SOC to the first target SOC. After step S505, the present control routine ends.

On the other hand, if at step S504 it is judged that there is an uphill slope near the charging location, the present control routine proceeds to step S506. At step S506, the target SOC setting part 42 calculates the chargeable amount of electric power. The chargeable amount of electric power is calculated based on the distance to the charging location, the grade information and driving history (mean vehicle speed etc.) of the route to the charging location, the current vehicle speed, etc.

Next, at step S507, the target SOC setting part 42 calculates the second target SOC based on the chargeable amount of electric power. Specifically, the target SOC setting part 42 subtracts the chargeable amount of electric power from the starting point SOC to thereby calculate the second target SOC. Therefore, the second target SOC becomes higher the smaller the chargeable amount of electric power. The starting point SOC is preset to a value enabling suppression of a drop in power performance of the vehicle 1 at an uphill slope (for example 25 to 40%). The starting point SOC is set to a value higher than the first target SOC at the charging location, that is, the arrival SOC.

Note that, the target SOC setting part 42 may calculate the starting point SOC based on the amount of electric power consumed on the uphill slope, the grade of the uphill slope, the length of the uphill slope, and the frequency by which the vehicle 1 is driven on an uphill slope when being driven near the charging location. By doing this, it is possible to more effectively shorten the operating time of the internal combustion engine 10 while keeping the power performance of the vehicle 1 from declining.

Specifically, the target SOC setting part 42 raises the starting point SOC the greater the amount of electric power of the battery 20 consumed on an uphill slope. Further, the target SOC setting part 42 raises the starting point SOC the greater the grade of the uphill slope. Further, the target SOC setting part 42 raises the starting point SOC the longer the uphill slope. Further, the target SOC setting part 42 lowers the starting point SOC the lower the frequency by which the vehicle 1 is driven along an uphill slope when being driven near a charging location. Note that, by raising the starting point SOC, the second target SOC also becomes higher and by lowering the starting point SOC, the second target SOC also becomes lower.

Further, when there are a plurality of uphill slopes near the charging location, the target SOC setting part 42 calculates the second target SOC for every uphill slope and sets the highest second target SOC to the final second target SOC. Note that, when there are a plurality of uphill slopes near the charging location, the target SOC setting part 42 may calculate the second target SOC only for the uphill slope closest to the charging location.

At step S508, the target SOC setting part 42 judges whether the first target SOC is equal to or more than the second target SOC. If it is judged that the first target SOC is equal to or more than the second target SOC, the present control routine proceeds to step S505. At step S505, the target SOC setting part 42 sets the target SOC to the first target SOC. After step S505, the present control routine ends.

On the other hand, if it is judged at step S508 that the first target SOC is less than the second target SOC, the present control routine proceeds to step S509. At step S509, the target SOC setting part 42 sets the target SOC to the second target SOC. After step S509, the present control routine ends.

In the third embodiment as well, the control routine of the processing for setting the driving mode of FIG. 6 is performed. The driving mode of the vehicle 1 is set based on the target SOC set in the control routine of the processing for setting the target SOC of FIG. 11.

### Fourth Embodiment

The control device of a hybrid vehicle according to a fourth embodiment is basically similar in configuration and control of a control device of a hybrid vehicle according to the first embodiment except for the points explained below. For this reason, below, the fourth embodiment of the present invention will be explained centered on the parts different from the first embodiment.

The target SOC of the battery 20 is set to a suitable value corresponding to the current location of the vehicle 1. For this reason, if the current location of the vehicle 1 cannot be detected, for example, if the GPS receiver 52 is broken, the target SOC cannot be set to a suitable value. As a result, on an uphill slope etc., the power performance of the vehicle 1 is liable to greatly fall.

Therefore, in the fourth embodiment, as failsafe control, the target SOC setting part 42 maintains the target SOC at a predetermined threshold value if the current location of the vehicle 1 cannot be detected. Due to this failsafe control, even if the current location of the vehicle 1 cannot be detected, it is possible to suppress a drop in the power performance of the vehicle 1.

<Processing for Calculation of Target SOC>

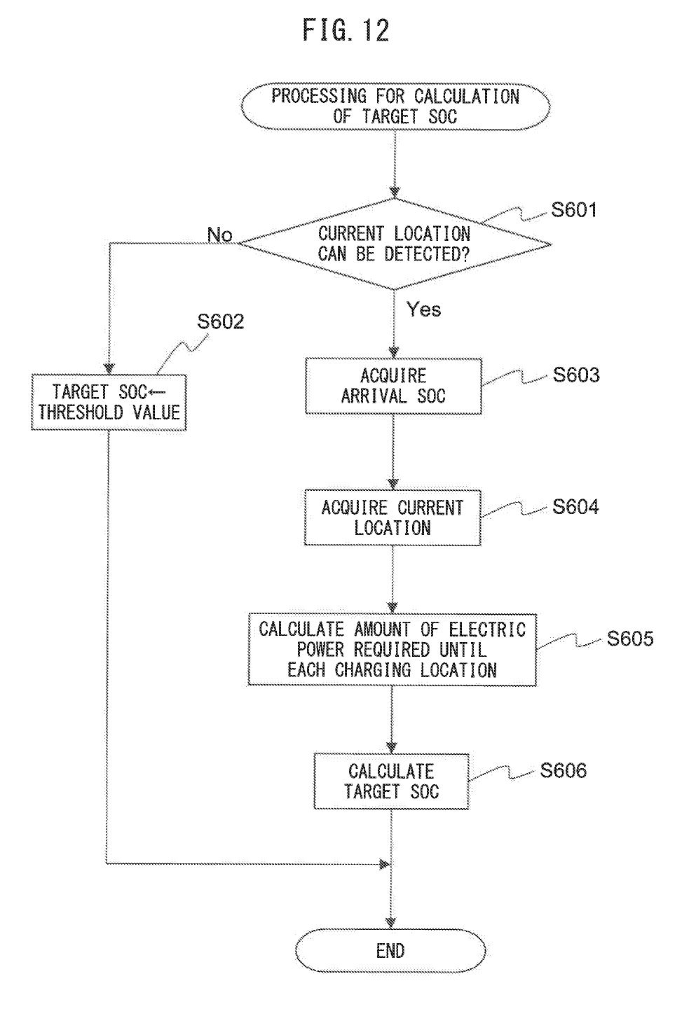

FIG. 12 is a flow chart showing a control routine of processing for calculation of the target SOC in the fourth embodiment of the present invention. In the present control routine, the target SOC is calculated. The present control routine is performed repeatedly by the ECU 40 at predetermined time intervals.

First, at step S601, the target SOC setting part 42 judges whether the current location of the vehicle 1 can be detected. If it is judged that the current location of the vehicle 1 cannot be detected, the present control routine proceeds to step S602. At step S602, the target SOC setting part 42 sets the target SOC to the threshold value. The threshold value is predetermined and is set to a value enabling suppression of a drop in the power performance of the vehicle (for example 25 to 40%). After step S602, the present control routine ends.

On the other hand, if it is judged at step S601 that the current location of the vehicle 1 can be detected, the present control routine proceeds to step S603. Step S603 to step S606 are similar to steps S201 to S204 of FIG. 5, so explanations will be omitted.

In the fourth embodiment as well, the control routine of processing for calculation of the arrival SOC of FIG. 4 and the control routine of processing for setting the driving mode of FIG. 6 are performed. In the control routine of processing for setting the driving mode of FIG. 6, the driving mode of the vehicle 1 is set based on the target SOC calculated in the control routine of processing for calculation of the target SOC of FIG. 12.

### Other Embodiments

Above, preferred embodiments according to the present invention were explained, but the present invention is not limited to these embodiments and can be corrected and changed in various ways within the language of the claims.

For example, the first motor-generator 12 may be an electric generator not functioning as an electric motor. Further, the second motor-generator 16 may be an electric motor not functioning as an electric generator.

Further, the hybrid vehicle 1 in the present embodiment is a so-called series parallel type hybrid vehicle. However, so long as the battery can be charged by an external power source, the hybrid vehicle 1 may be a so-called series type, parallel type, or other type of hybrid vehicle.

Further, the above-mentioned embodiments can be worked freely combined. For example, in the first embodiment, the third embodiment, and the fourth embodiment, in the same way as the second embodiment, the map database 53 may be omitted and grade information may be detected by the grade information detecting part 43.

Further, the fourth embodiment can be combined with the second embodiment and the third embodiment. In this case, step S601 and S602 of FIG. 12 are added before step S201 of FIG. 5 and step S501 of FIG. 11.

Further, in the third embodiment, in the same way as the second embodiment, the target SOC setting part 42 may lower the target SOC if the grade information detecting part 43 completes the detection of the grade information and does not detect an uphill slope near the charging location. In this case, in the control routine of the processing for setting the target SOC of FIG. 11, step S401 and step S403 of FIG. 8 are performed between step S502 and step S503. That is, the initial value of the arrival SOC is set to a value enabling suppression of a drop in the power performance of the vehicle 1 at an uphill slope (for example 25 to 40%) while the arrival SOC is made lower than the initial value after the detection of the grade information is completed.

### REFERENCE SIGNS LIST

1 hybrid vehicle
10 internal combustion engine
12 first motor-generator
16 second motor-generator
20 battery
40 electronic control unit (ECU)
41 output control part
42 target SOC setting part
70 external power source

1. A control device of a hybrid vehicle for controlling a hybrid vehicle comprising an internal combustion engine, electric motor, and a battery supplying electric power to the electric motor and able to be charged by output of the internal combustion engine and an external power source,
the control device of hybrid vehicle comprising:
a target state-of-charge setting part configured to set a target state of charge which is a target value of a state of charge of the battery; and
an output control part configured to control outputs of the internal combustion engine and the electric motor so that the state of charge of the battery becomes equal to or more than the target state of charge when the hybrid vehicle is being driven outside a charging location, wherein
the target state-of-charge setting part is configured to set the target state of charge based on an amount of electric power required for the hybrid vehicle to reach the charging location by output of only the electric motor, and grade information of a road near the charging location.

2. The control device of a hybrid vehicle according to claim 1, further comprising a grade information detecting part configured to detect the grade information based on a driving history of the hybrid vehicle.

3. The control device of a hybrid vehicle according to claim 2, wherein the target state-of-charge setting part is configured to lower the target state of charge if the grade information detecting part finishes detecting the grade information and does not detect an uphill slope near the charging location.

4. The control device of a hybrid vehicle according to claim 1, wherein the target state-of-charge setting part is configured to set the target state of charge so that the state of charge of the battery becomes an arrival state of charge when the hybrid vehicle reaches the charging location, and raise the arrival state of charge if there is an uphill slope near the charging location compared to if there is no uphill slope near the charging location.

5. The control device of a hybrid vehicle according to claim 4, wherein the target state-of-charge setting part is configured to raise the arrival state of charge the shorter a distance from the charging location to the uphill slope.

6. The control device of a hybrid vehicle according to claim 4, wherein the target state-of-charge setting part is configured to raise the arrival state of charge the shorter a driving time of the hybrid vehicle from the charging location to the uphill slope.

7. The control device of a hybrid vehicle according to claim 4, wherein the target state-of-charge setting part is configured to raise the arrival state of charge the larger an amount of electric power of the battery consumed at the uphill slope.

8. The control device of a hybrid vehicle according to claim 7, wherein the target state-of-charge setting part is configured to raise the arrival state of charge the larger a grade of the uphill slope.

9. The control device of a hybrid vehicle according to claim 7, wherein the target state-of-charge setting part is configured to raise the arrival state of charge the longer the uphill slope.

10. The control device of hybrid vehicle according to claim 4, wherein the target state-of-charge setting part is configured to lower the arrival state of charge the lower a frequency by which the hybrid vehicle is driven along the uphill slope when being driven near the charging location.

11. The control device of a hybrid vehicle according to claim 1, wherein the target state-of-charge setting part is configured to set the target state of charge so that the state of charge of the battery becomes an arrival state of charge when the hybrid vehicle reaches the charging location, and lower the arrival state of charge if there is a downhill slope near the charging location compared to if there is no downhill slope near the charging location.

12. The control device of a hybrid vehicle according to claim 1, wherein if there is an uphill slope near the charging location, the target state-of-charge setting part is configured to calculate a first target state of charge based on an amount of electric power required for the hybrid vehicle to reach the charging location by output of only the electric motor, calculate a second target state of charge based on an amount of electric power able to be charged to the battery by output of the internal combustion engine from a current location of the hybrid vehicle to the uphill slope, set the target state of charge to the first target state of charge when the first target state of charge is equal to or more than the second target state of charge, and set the target state of charge to the second target state of charge when the first target state of charge is less than the second target state of charge.

13. The control device of a hybrid vehicle according to claim 12, wherein the target state-of-charge setting part is configured to raise the second target state of charge the larger an amount of electric power of the battery consumed on the uphill slope.

14. The control device of a hybrid vehicle according to claim 13, wherein the target state-of-charge setting part is configured to raise the second target state of charge the larger a grade of the uphill slope.

15. The control device of a hybrid vehicle according to claim 13, wherein the target state-of-charge setting part is configured to raise the second target state of charge the longer the uphill slope.

16. The control device of a hybrid vehicle according to claim 12, wherein the target state-of-charge setting part is configured to lower the second target state of charge the lower a frequency by which the hybrid vehicle is driven along the uphill slope when being driven near the charging location.

17. The control device of hybrid vehicle according to claim 1, wherein the target state-of-charge setting part is configured to maintain the target state of charge at a predetermined threshold value if a current location of the hybrid vehicle cannot be detected.

18. A control device of a hybrid vehicle for controlling a hybrid vehicle comprising an internal combustion engine, electric motor, and a battery supplying electric power to the electric motor and able to be charged by output of the internal combustion engine and an external power source, wherein
the control device is configured to control outputs of the internal combustion engine and the electric motor so that a state of charge of the battery becomes equal to or more than a target state of charge when the hybrid vehicle is being driven outside a charging location, and set the target state of charge based on an amount of electric power required for the hybrid vehicle to reach the charging location by output of only the electric motor, and grade information of a road near the charging location.
